(19) United States
(12) Patent Application Publication
(10) Pub. No.: US 2026/0299514 A1
(43) Pub. Date: Oct. 1, 2026

(54) HIGH-RESOLUTION HOLOTOMOGRAPHY IMAGING APPARATUS AND METHOD BASED ON DIGITAL ABERRATION CORRECTION

(71) Applicants: KOREA ADVANCED INSTITUTE OF SCIENCE AND TECHNOLOGY, Daejeon (KR); TOMOCUBE, INC., Daejeon (KR)

(72) Inventors: YongKeun PARK, Daejeon (KR); Chulmin OH, Daejeon (KR); Herve Jerome HUGONNET, Daejeon (KR)

(73) Assignees: KOREA ADVANCED INSTITUTE OF SCIENCE AND TECHNOLOGY, Daejeon (KR); TOMOCUBE, INC., Daejeon (KR)

(21) Appl. No.: 19/530,846

(22) Filed: Feb. 5, 2026

(30) Foreign Application Priority Data
Mar. 31, 2025 (KR) 10-2025-0041346

(51) Int. Cl. G03H 1/04; G06T 5/80; G06T 7/00

(52) U.S. Cl. CPC G03H 1/0486; G03H 1/0443; G06T 5/80; G06T 7/0012; G03H 2226/02; G06T 2207/10072; G06T 2207/30004

(57) ABSTRACT

The present disclosure relates to a high-resolution holotomography imaging apparatus and method based on digital aberration correction. It is configured to detect aberration information for a sample using an optical memory effect, which represents the correlation between the angle of incident light and the angle of transmitted light waves from the sample, and to digitally correct an image of the sample by applying an image correction operation based on the aberration information.

### CROSS-REFERENCE TO RELATED APPLICATION(S)

This application claims the priority benefit of Korean Patent Application No. 10-2025-0041346, filed on Mar. 31, 2025, in the Korean Intellectual Property Office, the disclosure of which is incorporated herein by reference.

### BACKGROUND

### Field of the Invention

The present disclosure relates to a high-resolution holotomography (HT) imaging apparatus and method based on digital aberration correction.

### Description of the Related Art

When observing thick biological tissues with an optical microscope, light is severely scattered within the tissue, causing optical aberrations. This leads to a problem of degraded image quality. Especially in the case of deep tissue imaging, the generated aberrations make it difficult to clearly observe microstructures, which becomes a significant limiting factor in biological and histopathological research.

Conventional adaptive optics (AO) technology uses optical elements such as deformable mirrors or a method of directly measuring wavefront distortion by inserting a guide star into the sample to correct such aberrations. However, in biological tissues, the invasive insertion of such guide stars is required, making practical application difficult. Furthermore, in the case of thick tissues with severe multiple scattering, complex aberrations exceeding the limits of physical correction devices occur, thereby restricting the application of AO. To overcome this, computational AO techniques based on non-guide star methods that estimate and correct aberrations by maximizing the clarity of the sample's internal structure are also being researched. However, these clarity-based techniques have limitations, such as inconsistent effectiveness depending on the sample and convergence to local maxima when accurately correcting high-order aberrations.

Recently, optical matrix-based AO techniques, such as reflection/transmission matrix methods, have emerged, attempting to measure and correct aberrations in deep tissues without a separate guide star. However, these methods are complex to implement and have not been sufficiently applied to real-time 3D imaging. Consequently, there is a need for a new approach that can precisely correct aberrations within thick biological tissues in real-time to obtain high-resolution images.

### SUMMARY

This disclosure provides a high-resolution holotomography imaging apparatus and method based on digital aberration correction.

The invention involves a method of operating a computing device and a computing device itself. The method comprises detecting aberration information for a sample using an optical memory effect, which represents a correlation between the angle of incident light and the angle of transmitted light for the sample, and then digitally correcting an image of the sample by applying an image correction operation based on the detected aberration information. The computing device includes a processor configured to perform these steps.

By utilizing the optical memory effect, aberrations in biological tissues can be detected and corrected in real-time through digital computation, thereby providing high-resolution images. This approach enables real-time aberration correction in a transmission-type holotomography device, even in the presence of tissue movement, by leveraging the angular correlation (tilt-tilt correlation) of the optical memory effect.

### BRIEF DESCRIPTION OF THE DRAWINGS

FIG. 1 is a diagram schematically illustrating a computing device for digital aberration correction according to various embodiments.

FIG. 2 is a diagram for exemplarily explaining an optical memory effect considered in various embodiments.

FIG. 3 is a diagram schematically illustrating a method of operation of a computing device for digital aberration correction according to various embodiments.

### DETAILED DESCRIPTION

Hereinafter, the present disclosure provides a high-resolution holotomography imaging apparatus and method based on digital aberration correction.

Technology utilizing the optical memory effect uses the physical characteristic that when the incident angle of light is slightly changed even in a complex scattering medium, the scattered light also tilts at the same angle, having a correlation, and thus has the potential to effectively correct aberrations within thick tissues. The present disclosure aims to establish a technical foundation that can significantly improve image quality even in deep tissue environments where conventional guide-star-free adaptive optics (AO) methods fail, by introducing this optical memory effect into aberration correction.

Holotomography (HT) is a technique that reconstructs 3D refractive index distribution images by fusing multi-angle optical images, similar in principle to X-ray CT, and is known to have the advantage of observing the 3D structure of cells or tissues label-free. However, when this technique is applied to thick and heterogeneous biological tissues, there is a limitation that it is difficult to clearly observe fine structures in deep tissue with conventional HT alone due to severe scattering within the sample and resulting aberrations. In fact, conventional optical microscopy techniques had limitations in observing the inside of thick tissues at high resolution for extended periods, requiring additional sample processing (e.g., tissue sectioning or clearing, fluorescence staining, etc.), and otherwise, the information obtainable was limited. In contrast, the present disclosure enables direct acquisition of high-resolution images of thick tissues, which were difficult to observe with conventional methods, by combining digital aberration correction techniques with an HT system.

Conventional adaptive optics (AO) techniques have been developed in fields such as retinal imaging and astronomy, and correct optical aberrations by real-time control of deformable mirrors or optical elements. However, as mentioned above, when observing deep biological tissues, it is difficult to directly measure aberrations through optical systems, and the frequent requirement to insert artificial guide stars into the sample has limited its application in experimental biology. For example, there is a method of measuring wavefront distortion by embedding small fluorescent beads within the sample, but this is invasive and difficult to apply to actual tissues. For these reasons, several alternatives for non-invasive aberration correction have been studied. Typically, there is an approach that optimizes aberrations by using the fine structures of the sample itself as a measure of image sharpness. These methods are implementable without separate optical elements and are called guide-star-free AO, but problems have been reported where convergence speed is slow or the final image quality is limited due to falling into local optima in the presence of strong aberrations. These limitations are particularly pronounced as tissue thickness and complexity increase, and there are cases where sufficient correction effects cannot be achieved for moving biological samples or those with high-order aberrations.

Optical memory effect and matrix-based correction: Recent studies have proposed computational AO techniques that correct aberrations by utilizing the concept of a transmission matrix in scattering media. For example, a reflection matrix (spatial reflection matrix) or a transmission matrix is a method that describes how reflected or transmitted wavefronts are generated for a specific wavefront incident on a medium, and methods have been reported that extract distortion information caused by the sample by analyzing the correlation between the reflection matrix or transmission matrix. These matrix-based methods operate without guide stars, independent of the internal structure of the sample, and are theoretically known to be able to correct even complex aberrations occurring in deep tissues. However, these techniques experimentally require collecting a very large amount of data and performing complex calculations, making them somewhat difficult to apply immediately to real-time microscopic imaging. Furthermore, there are no examples in existing literature or patents of real-time aberration detection and correction in transmission-type holotomography devices using the angular correlation of the optical memory effect.

As such, conventional techniques have not fully resolved the aberration problem in thick tissues, and an efficient alternative for this was lacking. The present disclosure is designed to fill this gap, demonstrating excellent correction performance even in thick biological tissues through digital aberration detection and correction technology utilizing the optical memory effect. In particular, the method of the present disclosure has been proven to operate stably even in environments where conventional guide-star-free AO methods fail, and it offers significant superiority over existing technologies in that it enables real-time high-resolution observation of fine structures in deep tissues. Furthermore, since aberrations are corrected software-wise without a separate physical optical correction device, the system configuration is simple, and image quality can be maintained even when the sample is moving, facilitating observation of actual biological samples.

The above content can be mathematically described as follows.

### Mathematical Model for Aberration and Scattering

To effectively detect and correct aberrations, a robust mathematical model encompassing both aberration and scattering phenomena is essential. To describe aberrations caused by a sample, traditional AO models separately describe scattering events in the aberrating medium and at the target plane.

Scattering in irregular media is characterized by small scattering angles due to the large anisotropy factor of biological tissues. Because the scattering angle is small, light passing through the aberrating medium maintains significant lateral correlation to avoid confusion with angular correlation. Therefore, the scattering response within this correlation range can be described by a single PSF P(r), and the correlated region is called an isoplanatic patch. To select a specific patch, the measured wavefront is typically multiplied by a window function centered on that patch.

In contrast, scattering at the target plane is distinguished by a broad angular spectrum and a larger angular correlation range. Conventional AO models represent target scattering by multiplying the target plane S(r) by a complex reflection or transmission coefficient. This formula, widely used in synthetic aperture microscopy and Fourier ptychography, results in full-range angular correlation of the scattered wave. By maximizing this correlation, matrix-based AO methods such as CLASS and distortion matrix can correct aberrations and obtain 2D images of the target S(r).

The overall relationship between the emitted light Eₒᵤₜ and the incident light Eᵢₙ fields (complex amplitudes) can be found by combining two types of scattering events as in the following [Mathematical Formula 1].

$${E}_{out} ( r ) = {P}_{out} ( r ) * [ ( {E}_{in} ( r ) * {P}_{in} ( r ) ) S ( r ) ] \qquad [ Mathematical Formula 1 ]$$

Here, assuming Eₒᵤₜ and Eᵢₙ are appropriately windowed, r denotes the 2D coordinates of the target plane or image plane, Pᵢₙ and Pₒᵤₜ each represent the PSF of the irregular medium in the incoming and outgoing optical paths, respectively, and * denotes the 2D convolution operator.

To use the above [Mathematical Formula 1], the target plane must be set at a specific depth within the sample. For imaging deep biological tissues, time-gating technology, the basic principle of OCT, has been introduced in reflection-mode microscopy to collect reflected waves from a specific depth. Forward scattering in the tissue above the target plane exhibits a much narrower angular spectrum than backscattering, allowing scattering outside the target plane to be integrated into the PSF using an appropriate window function.

This also highlights the limitations of conventional guide-star-free AO methods. Strong aberrations and multiple scattering degrade windowing and time-gating performance when imaging deeper. Furthermore, since time-gating technology cannot provide depth sectioning for transmitted light, the thickness of the target object is limited to a few wavelengths in transmission mode AO. In such cases, the above [Mathematical Formula 1] cannot be applied, and conventional guide-star-free AO methods generally converge to poor local maxima.

To overcome this limitation, a linear operator T is introduced to represent scattering from the target volume instead of S(r), thereby generalizing the above [Mathematical Formula 1] as in the following [Mathematical Formula 2].

$${E}_{out} ( r ) = {P}_{out} ( r ) * T [ {E}_{in} ( r ) * {P}_{in} ( r ) ] \qquad [ Mathematical Formula 2 ]$$

It should be noted that the linear operator T is equivalent to the reflection or transmission matrix of the sample when imaging reflected or transmitted light, respectively. As the target dimension increases, the PSF described by this model is averaged over the depth within the target volume.

### Aberration Detection Using Angular Memory Effect

To retrieve the PSFs Pᵢₙ and Pₒᵤₜ from the measured field Eₒᵤₜ, the optical memory effect, which describes the fundamental correlation of transmitted or reflected optical fields under elastic scattering, is utilized. While previous studies dealt with intensity correlations, correlations in the complex field can be established using the Siegert relation. In this study, if the incident wave is tilted within the angular range known as the memory effect range, the scattered wave maintains correlation and tilts at the same angle, specifically utilizing the angular memory effect.

By expressing T using a plane wave basis in matrix notation, T(kₒᵤₜ; kᵢₙ)=∫T[e^{ik}^{ᵢₙ}^{·r}]e^{-ik}^{ₒᵤₜ}^{·r}dr, and the angular memory effect can be described as in the following [Mathematical Formula 3].

$$\frac{\vert 〈 T ( {k}_{out} + Δ k ; {k}_{in} + Δ k ) T * ( {k}_{out} ; {k}_{in}}{\begin{matrix}{〈 {\vert T ( {k}_{out} + Δ k ; {k}_{in} + Δ k ) \vert}^{2} 〉}^{1 / 2} \\ {〈 \vert {T ( {K}_{out} ; {k}_{in} )}^{2} 〉}^{1 / 2}\end{matrix}} = 1 - 𝒪 ( {Δ k}^{2} / {k}_{MER}^{2} \qquad [ Mathematical Formula 3 ]$$

Here, kₒᵤₜ and kᵢₙ respectively denote the 2D wave vectors of the emitted light and incident light parallel to the image plane, Δk denotes the shift in the wave vector corresponding to the tilt of the incident wave, k_{MER} denotes the memory effect range, and O(Δk²/k_{MER}²) denotes the correlation term of the order of Δk²/k_{MER}².

To utilize the above [Mathematical Formula 3], the output field Eₒᵤₜ is measured under plane wave illumination while varying the incident wave vector kᵢₙ.

$${\tilde{E}}_{out} ( {k}_{out} ; {k}_{in} ) = {\tilde{P}}_{out} ( {k}_{out} ) T ( {k}_{out} ; {k}_{in} ) {\tilde{P}}_{in} ( {k}_{in} ) \qquad [ Mathematical Formula 4 ]$$

Here, the 2D Fourier transform \tilde{f}(k)=∫f(r)e^{-ik·r}dr and the convolution theorem \tilde{f}(k)\tilde{g}(k)=∫f(r)*g(r)e^{-ik·r}dr were used.

If the two fields are measured with slightly shifted incident wave vectors, the above [Mathematical Formula 3] can be directly applied to the above [Mathematical Formula 4].

$${\tilde{E}}_{out} ( {k}_{out} + Δ k ; {k}_{in} + Δ k ) {E}_{out} * ( {k}_{out} ; {k}_{in} ) = {\tilde{P}}_{out} ( {k}_{out} + Δ k ) {\tilde{P}}_{out} ( k ) {\vert T ( {k}_{out} ; {k}_{in} ) \vert}^{2} {\tilde{P}}_{in} ( {k}_{in} + Δ k ) {\tilde{P}}_{in} * ( {k}_{in} ) + 𝒪 ( {Δ k}^{2} / {k}_{MER}^{2} ) \qquad [ Mathematical Formula 5 ]$$

Here, the aberration matrix is defined as the left side of the above [Mathematical Formula 5].

$${A}_{Δ k} ( {k}_{out} ; {k}_{in} ) = {\tilde{E}}_{out} ( {k}_{out} + Δ k ; {k}_{in} + Δ k ) {\tilde{E}}_{out} * ( {k}_{out} ; {k}_{in} ) \qquad [ Mathematical Formula 6 ]$$

Then, the arguments of the aberration matrix represent the aberrations of the emitted light and incident light in the columns and rows, respectively.

$$arg [ {A}_{Δ k} ( {k}_{out} ; {k}_{in} ) ] = ∇ {ϕ}_{out} ( {k}_{out} ) \cdot Δ k + ∇ {ϕ}_{in} ( {k}_{in} ) \cdot Δ k + 𝒪 ( {Δ k}^{2} / {k}_{MER}^{2} ) \qquad [ Mathematical Formula 7 ]$$

Here, Φₒᵤₜ(kₒᵤₜ) and Φᵢₙ(kᵢₙ) denote the phases (arguments) of the emitted aberration function and incident aberration function, respectively, referred to as \tilde{P}ᵢₙ and \tilde{P}ₒᵤₜ, and the approximation Φ(k+Δk)−φ(k)=∇Φ(k)·Δk+O(Δk²) was used. The last term of the above [Mathematical Formula 7] represents the correlation effect. This term arises because the target volume thickness is not zero, causing the PSF to vary within the target volume. Subsequently, the aberration function obtained from the aberration matrix represents the average aberration within the target volume.

Factoring the aberration matrix allows individual retrieval of the emitted aberration function and the incident aberration function. The simplest method is to perform singular value decomposition (SVD) of the aberration matrix and identify the first left and right singular vectors as the emitted aberration function and incident aberration function, respectively. In this work, the projection power method is used. For successful factorization, the shift of the incident wave vector (Δk) must be carefully chosen such that the magnitudes of the first and second terms of the above [Mathematical Formula 7] are greater than the magnitude of the last term, and noise is present.

As a result of the factorization, the difference in the aberration function according to the shift direction (Δk) can be obtained. To calculate the gradient of the aberration function, the aberration matrices for at least two different shift directions (Δk₁ and Δk₂) must be measured and factored. In the next step, an inverse gradient algorithm is applied to an arbitrary boundary to obtain the aberration function. Finally, aberrations are computationally corrected through deconvolution of the output field Eₒᵤₜ and the retrieved output PSF Pₒᵤₜ. Here, correction of the incident aberration Pᵢₙ is not necessary because its effect is limited to a constant phase offset for each plane wave generation. If the sample is illuminated by waves other than plane waves, the incident aberration must also be corrected.

Ideally, the proposed method requires only three measurements to reconstruct aberrations. However, to ensure a uniform signal-to-noise ratio (SNR) across the entire NA, it is necessary to measure various fields with varying incident wave vectors.

Now, various embodiments of the present disclosure will be described with reference to the accompanying drawings.

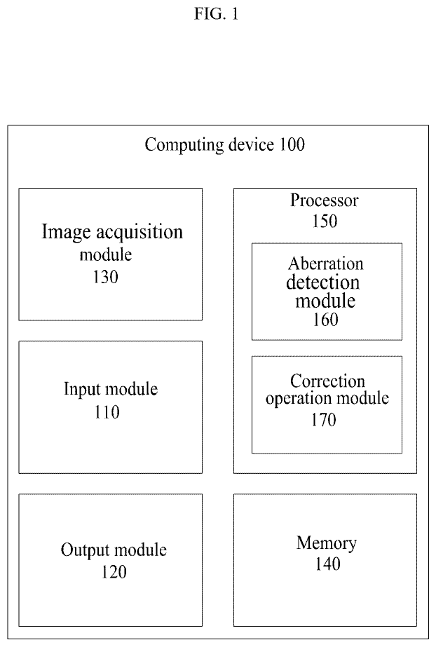

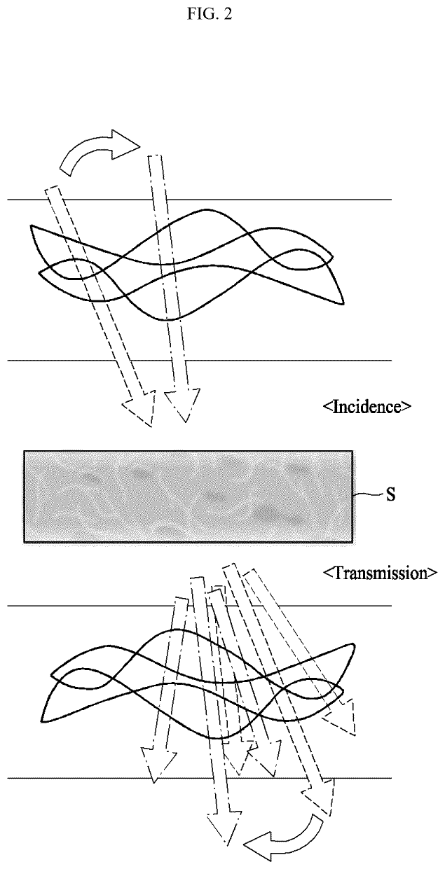

FIG. 1 is a diagram schematically illustrating a computing device (100) for digital aberration correction according to various embodiments. FIG. 2 is a diagram for exemplarily explaining the optical memory effect considered in various embodiments.

Referring to FIG. 1, the computing device (100) may be provided to digitally detect and correct optical aberrations caused by a sample (S) by analyzing phase differences according to changes in the incident angle of light, based on the optical memory effect. Specifically, the computing device (100) extracts aberration information by comparing phase changes in the output light field induced by small variations in the incident angle of light, and improves image resolution by removing the thus detected aberrations through a correction operation. This approach provides even more powerful aberration correction effects than conventional adaptive optics technology, enabling clearer capture of structures within thick biological tissues. In various embodiments, the computing device (100) may include a transmission-type holotomography device. Specifically, the computing device (100) may include at least one of an input module (110), an output module (120), an image acquisition module (130), a memory (140), or a processor (150). Here, at least one of the components of the computing device (100) may be omitted, and at least one other component may be added. In some embodiments, at least two of the components of the computing device (100) may be implemented as a single integrated circuit.

The input module (110) can input signals to be used by at least one component of the computing device (100). The input module (110) may be configured to detect signals directly input by a user or to sense changes in the surroundings and generate signals. For example, the input module (110) may include at least one of a microphone, at least one physical button, or a touch pad. Meanwhile, the input module (110) may include a receiving device configured to receive signals from an external device. The receiving device will be described in more detail later.

The output module (120) can output information to the outside of the computing device (100). The output module (120) may be implemented as a haptic display to provide a haptic interface. For this purpose, the output module (120) may include at least one of a display module configured to visually output information or an audio output module configured to audibly output information. For example, the audio output device may include at least one of a speaker or a receiver. Meanwhile, the output module (120) may include at least one transmitting device capable of wirelessly transmitting information. The transmitting device will be described in more detail later.

According to some embodiments, the receiving device and the transmitting device may be implemented as a communication module. The communication module can perform communication with an external device from the computing device (100). The communication module establishes a communication channel between the computing device (100) and an external device, and performs communication with the external device through the communication channel. The communication module may include at least one of a wired communication module or a wireless communication module. The wired communication module is wired to an external device and can communicate wiredly. The wireless communication module may include at least one of a short-range communication module or a long-range communication module. The short-range communication module can communicate with an external device via a short-range communication method. For example, the short-range communication method may include at least one of Bluetooth, WiFi direct, or infrared data association (IrDA). The long-range communication module can communicate with an external device via a long-range communication method. Here, the network may include at least one of a cellular network, the Internet, or a computer network such as a LAN (local area network) or a WAN (wide area network).

The image acquisition module (130) can acquire an image of the sample (S). Specifically, the image acquisition module (130) can illuminate the sample (S) with a highly coherent light source such as a laser and detect the transmitted light in an interferometric manner to reconstruct the 3D refractive index distribution of the sample (S). In some embodiments, the image acquisition module (130) may use a digital mirror device (DMD) or other incident angle adjusters to illuminate the sample (S) at various angles, and the transmitted light can be received through an objective lens and recorded by an image sensor (CMOS or CCD).

The memory (140) can store various data used by at least one component of the computing device (100). For example, the memory (140) may include at least one of volatile memory or non-volatile memory. Data may include at least one program and associated input data or output data. A program may be stored as software including at least one instruction in the memory (140), and may include at least one of an operating system, middleware, or an application.

The processor (150) can execute programs in the memory (140) to control at least one component of the computing device (100). Through this, the processor (150) can perform data processing or operations. At this time, the processor (150) can execute instructions stored in the memory (140). In various embodiments, the processor (150) can detect aberration information for the sample (S) using the optical memory effect and digitally correct an image for the sample (S) based on the aberration information. More specifically, the processor (150) can reconstruct a 3D refractive index image from multi-angle hologram data acquired through the image acquisition module (130). In this process, the processor (150) can remove aberrations in the image based on the aberration information. Specifically, the processor (150) may include an aberration detection module (160) and a correction operation module (170).

The aberration detection module (160) can detect aberration information for the sample (S) using the optical memory effect. The optical memory effect can indicate the correlation between the incident angle of light on the sample (S) and the angle of the transmitted light wave. In other words, as shown in FIG. 2, the optical memory effect can indicate a correlation where if the incident angle of light on the sample (S) is slightly changed, the angle of the light wave transmitted from the sample (S) also changes. Specifically, the aberration detection module (160) can detect aberration information by comparing the phase distributions of light waves transmitted from the sample (S) corresponding to different incident angles of light on the sample (S). More specifically, the aberration detection module (160) can detect aberration information by minutely changing the incident angle of light on the sample (S), measuring the phase distributions of light waves transmitted from the sample (S), and comparing the phase distributions. Here, the aberration information can be detected as an aberration phase map. In this manner, the aberration detection module (160) can acquire aberration information using the scattering characteristics of the sample (S) itself without a separate reference light source, by analyzing the output phase change (angular correlation) according to small angular tilts. This aberration detection module (160) can precisely estimate aberrations even in complex multiple scattering environments.

The correction operation module (170) can digitally correct an image for the sample (S) based on the aberration information. Specifically, the correction operation module (170) can remove the effect of aberrations from holographic images and reconstructed tomographic images by performing digital deconvolution operations using the detected aberration phase map. For this purpose, the correction operation module (170) applies inverse filtering or regularized inverse filtering techniques based on the complex wavefront information of the image and the aberration phase map to restore resolution degraded by aberrations. This digital correction process can be performed in real-time, thereby improving the 3D image quality of the sample (S) and obtaining high-resolution images with significantly improved contrast and resolution of fine structures compared to before aberration correction. This correction operation module (170) can be implemented to enable real-time processing by applying image correction operations using high-speed parallel processing devices such as GPUs.

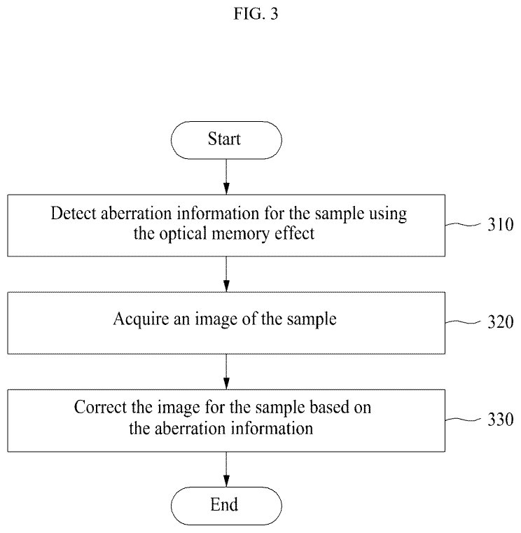

FIG. 3 is a diagram schematically illustrating an operation method of the computing device (100) for digital aberration correction according to various embodiments.

Referring to FIG. 3, first, in step 310, the computing device (100) can detect aberration information for the sample (S) using the optical memory effect. The optical memory effect can indicate the correlation between the incident angle of light on the sample (S) and the angle of the transmitted light wave. In other words, as shown in FIG. 2, the optical memory effect can indicate a correlation where if the incident angle of light on the sample (S) is slightly changed, the angle of the light wave transmitted from the sample (S) also changes. Specifically, the processor (150), particularly the aberration detection module (160), can detect aberration information by comparing the phase distributions of light waves transmitted from the sample (S) corresponding to different incident angles of light incident on the sample (S). More specifically, the aberration detection module (160) can detect aberration information by minutely changing the incident angle of light on the sample (S), measuring the phase distributions of light waves transmitted from the sample (S), and comparing the phase distributions. Here, the aberration information can be detected as an aberration phase map. In this manner, the aberration detection module (160) can acquire aberration information using the scattering characteristics of the sample (S) itself without a separate reference light source, by analyzing the output phase change (angular correlation) according to small angular tilts. This aberration detection module (160) can precisely estimate aberrations even in complex multiple scattering environments.

Next, in step 320, the computing device (100) can acquire an image of the sample. The image acquisition module (130) can acquire an image of the sample (S). Specifically, the image acquisition module (130) can illuminate the sample (S) with a highly coherent light source such as a laser and detect the transmitted light in an interferometric manner to reconstruct the 3D refractive index distribution of the sample (S). In some embodiments, the image acquisition module (130) may use a digital mirror device (DMD) or other incident angle adjusters to illuminate the sample (S) at various angles, and the transmitted light can be received through an objective lens and recorded by an image sensor (CMOS or CCD).

Next, in step 330, the computing device (100) can digitally correct the image for the sample (S) based on the aberration information. Specifically, the processor (150), particularly the correction operation module (170), can remove the effect of aberrations from holographic images and reconstructed tomographic images by performing digital deconvolution operations using the detected aberration phase map. For this purpose, the correction operation module (170) can restore resolution degraded by aberrations by applying inverse filtering or regularized inverse filtering techniques based on the complex wavefront information of the image and the aberration phase map. This digital correction process can be performed in real-time, thereby improving the 3D image quality of the sample (S) and obtaining high-resolution images with significantly improved contrast and resolution of fine structures compared to before aberration correction. This correction operation module (170) can be implemented to enable real-time processing by applying image correction operations using high-speed parallel processing devices such as GPUs.

According to the present disclosure, aberrations in biological tissues can be detected utilizing the optical memory effect, and through this, aberrations can be corrected in real-time through digital computation, thereby providing high-resolution images. The present disclosure enables real-time aberration correction in a transmission-type holotomography device using the angular correlation of the optical memory effect. The present disclosure can stably correct aberrations even in the presence of tissue movement.

The technology of the present disclosure has been applied to thick human tissue samples in a transmission-type holotomography device, and through this, it has been demonstrated that real-time high-resolution imaging is possible even in actual thick tissues. Experimental results using the technology of the present disclosure confirmed that aberrations can be effectively corrected even in environments where conventional optical aberration correction methods fail. This means that the algorithm of the present invention operates stably even under conditions where image quality significantly deteriorates due to very severe aberrations or multiple scattering with conventional methods. In particular, it has been shown that even when there is movement within the sample, the image quality is maintained stably without noticeable degradation. In other words, the technology of the present disclosure is applicable to dynamic biological tissues, enabling the acquisition of clear images in real-time. For example, applying the technology of the present disclosure to holotomography images of human tissue, it was confirmed that fine structures that were difficult to identify before aberration correction became clearly visible after correction. Furthermore, thanks to aberration correction, the movement of micrometer-sized particles, which were previously blurred, could be precisely tracked and analyzed. In summary, the technology of the present disclosure enables the observation of 3D structures of thick tissues without damage (while maintaining structural integrity), and furthermore, it is an innovative approach that enables non-invasive precise analysis of various biological samples.

The high-resolution holotomography technology based on digital aberration correction of the present disclosure is a groundbreaking technology that can be utilized in various fields such as life science research, tissue pathology diagnosis, and new drug development. Through this technology, it has become possible to acquire high-resolution images in real-time while maintaining the structural integrity of thick biological tissues, and by overcoming the limitations of conventional adaptive optics technology, it is expected to establish itself as a powerful tool enabling non-invasive precise analysis of biological tissues in clinical and research settings. For example, in histopathological diagnosis, 3D observation of tissue samples in vivo can increase diagnostic accuracy, and in neuroscience, the fine structures and activities of living brain tissues can be monitored in real-time. Furthermore, in the pharmaceutical and biotechnology fields, it can be used to continuously track changes in organoids or 3D cell cultures to evaluate the efficacy and toxicity of new drugs, thereby increasing research efficiency. As such, the present invention is expected to open new horizons in deep tissue imaging research and contribute significantly to related academic and industrial fields by providing information that was difficult to obtain with conventional optical technologies. In particular, due to the nature of this technology, which allows non-invasive viewing inside living organisms, it is expected to be applied in the future for real-time image-guided diagnosis or precise surgical guidance in medical settings, and can directly assist in patient treatment.

Various embodiments described in this document and the terms used herein are not intended to limit the technology described in this document to specific embodiments, and it should be understood that they include various modifications, equivalents, and/or alternatives of the corresponding embodiments. In relation to the description of the drawings, similar reference numerals may be used for similar components. A singular expression may include plural expressions unless the context clearly indicates otherwise. In this document, expressions such as “A or B”, “at least one of A and/or B”, “A, B or C”, or “at least one of A, B and/or C” may include all possible combinations of the listed items. Expressions such as “first”, “second”, “firstly”, or “secondly” may modify the corresponding components regardless of order or importance, and are used only to distinguish one component from another, without limiting the corresponding components. When a certain (e.g., first) component is mentioned as being “(physically or functionally) connected” or “coupled” to another (e.g., second) component, it means that the certain component may be directly connected to the other component, or connected through another component (e.g., a third component).

According to various embodiments, each of the described components may include a single or multiple entities. According to various embodiments, one or more of the aforementioned components or operations may be omitted, or one or more other components or operations may be added. Alternatively or additionally, multiple components may be integrated into a single component. In such a case, the integrated component performs one or more functions of each of the multiple components in the same way as performed by the corresponding component among the multiple components before integration, or similarly.

What is claimed is:

1. A method of operating a computing device, the method comprising:
detecting aberration information for a sample using an optical memory effect that indicates a correlation between an incident angle of light on the sample and an angle of a transmitted light wave; and
applying an image correction operation to an image of the sample based on the aberration information, thereby digitally correcting the image.

2. The method of claim 1, wherein the detecting aberration information comprises:
comparing phase distributions of light waves transmitted from the sample, each corresponding to different incident angles of light incident on the sample, to detect the aberration information.

3. The method of claim 1, wherein the computing device comprises a transmission holotomography device.

4. The method of claim 2, wherein the detecting aberration information comprises:
measuring the phase distributions while varying the incident angle of light on the sample; and
comparing the phase distributions to detect the aberration information.

5. The method of claim 1, wherein the digitally correcting the image comprises:
applying the image correction operation using high-speed parallel processing.

6. A computing device comprising:
a memory; and
a processor connected to the memory and configured to execute at least one instruction stored in a storage,
wherein the processor is configured to:
detect aberration information for a sample using an optical memory effect that indicates a correlation between an incident angle of light on the sample and an angle of a transmitted light wave; and
apply an image correction operation to an image of the sample based on the aberration information, thereby digitally correcting the image.

7. The computing device of claim 6, wherein the processor is configured to:
compare phase distributions of light waves transmitted from the sample, each corresponding to different incident angles of light incident on the sample, to detect the aberration information.

8. The computing device of claim 6, wherein the computing device comprises a transmission holotomography device.

9. The computing device of claim 7, wherein the processor is configured to:
measure the phase distributions while varying the incident angle of light on the sample; and
compare the phase distributions to detect the aberration information.

10. The computing device of claim 6, wherein the processor is configured to:
apply the image correction operation using high-speed parallel processing.
